(19) United States
(12) Patent Application Publication
(10) Pub. No.: US 2019/0390561 A1
(43) Pub. Date: Dec. 26, 2019

(54) DOUBLE-FAN DUAL-TURBINE RENEWABLE ENERGY SYSTEM

(71) Applicants: JOVENA DEFRANCIA, WAILUKU, HI (US); RERI SEPTIMO, WAILUKU, HI (US)

(72) Inventors: JOVENA DEFRANCIA, WAILUKU, HI (US); RERI SEPTIMO, WAILUKU, HI (US)

(21) Appl. No.: 16/018,048

(22) Filed: Jun. 26, 2018

(51) Int. Cl. F01D 15/10; H02K 7/18; H02J 3/38; H02J 7/00

(52) U.S. Cl. CPC F01D 15/10; H02K 7/1838; H02J 3/386; H02J 7/345; F05D 2220/30; F05D 2260/42; H02J 7/0021

(57) ABSTRACT

Using powered-fans coupling to a magnetic levitation gearless generator wind turbines, to produce energy power. High powered-fans to its capacity; creates wind power supporting wind turbines to produce electricity power. At 1-12 mph winds, the wind turbines can create 40-320 kw/hr. Depending on the area and the amount of electricity for your needs. For example: the bigger in size, (the powered-fans) the higher in wind factor. The volume of electricity power produced in seconds, collected from turbines. This methods productivity comprising: to renewable and sustainable off-grid and/or grid cycling energy systems. As such, economical, effective and efficient.

### FIELD OF INVENTION

This invention relates to dual-wind powered-fans coupling magnetic gearless generator wind turbine.

### BACKGROUND

Today's, energy resources are made from fossil fuel. Studies show that its decreasing, causes health problems, and non-sustainable.

Power companies and new technology are turning to renewable energy resources. Hybrid systems, green power, wind power (to name a few).

The need of developing clean and renewable energy helps to solve the problems of depleting fossil fuel.

Wind turbines and solar power supersedes over fossil fuel in countries where its technologies and economy currently developing.

The disadvantage of producing energy power through wind turbines, and solar power is perhaps there's no wind to spin turbines, and little sunlight to solar panels (PV). To support for power-up, a battery bank charge controller, inverter, switchboard panel, capacitor can be added for your needs. It can also be costly depending on the demands.

The dual powered-fans (DPF) where in the wind shroud confines the circulating winds, coupling the (MGGWTs) producing instant energy power. As a result, it creates its own winds by the said powered-fans, to its advantages.

The (DPF) comprising an alternator “field,” (varies) depending on what and volume of energy power needed. To be size with the (DPF).

In this case a turbo alternator can be used for higher capacity coupling to wind vane blades (optional).

The advantage of using turbo alternators is the permanent magnet for its magnetic “field,” built in for stationery rotating. Especially for wind turbines.

With the support of said back up device units (in 0006) it can be manufactured as a renewable energy resource system.

The dual powered-fans (DPF), (MGGWTs) can be designed to grid tie-in and off grid energy resource systems.

This method will become an inspiring notion added to other renewable energy systems providing its manufactured thoroughly.

### DETAILED DESCRIPTION OF THE EMBODIMENTS

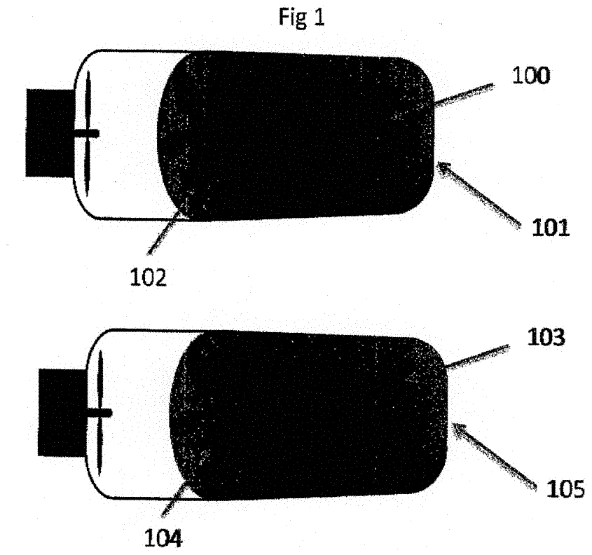

The (DPF) (MGGWTs) systems as shown in FIGS. 1-3, design to build and manufactured as such.

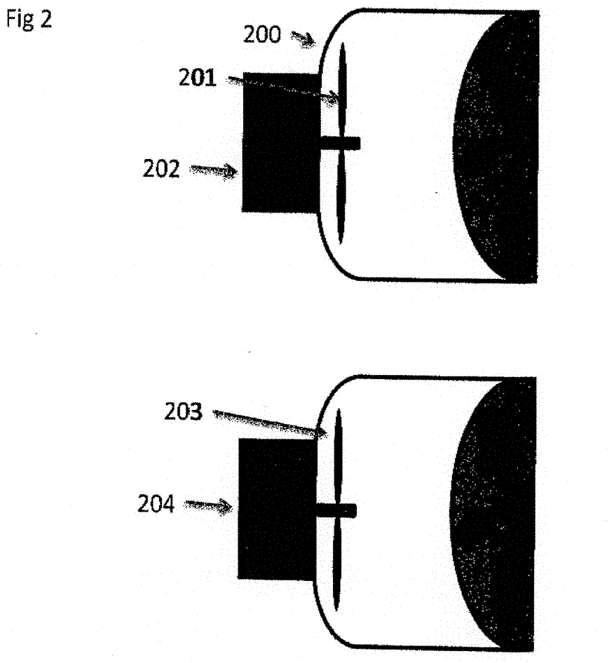

FIG. 2 200 the wind shroud is attached to (MGGWTs) 100 in FIG. 1. Comprising wind vane blades 201 coupling alternator 202 FIG. 2.

An alternator that has a permanent magnet for its magnetic “field,” uses for stationary rotating. Turbo alternators can be advantageous for the (DPF). Using turbo charge alternators increases the efficiency and power output of energy by its drives force, increases the winds mph factor supporting 100.

FIG. 1 102 multiple fin wind blades for dynamic propelling coupling (MGGWTs) 100 producing the energy power.

The built-in generator 101 converts obtained energy into electrical energy as the output. The flow of energy generated charges and comprising to other device units to make-up a renewable energy system.

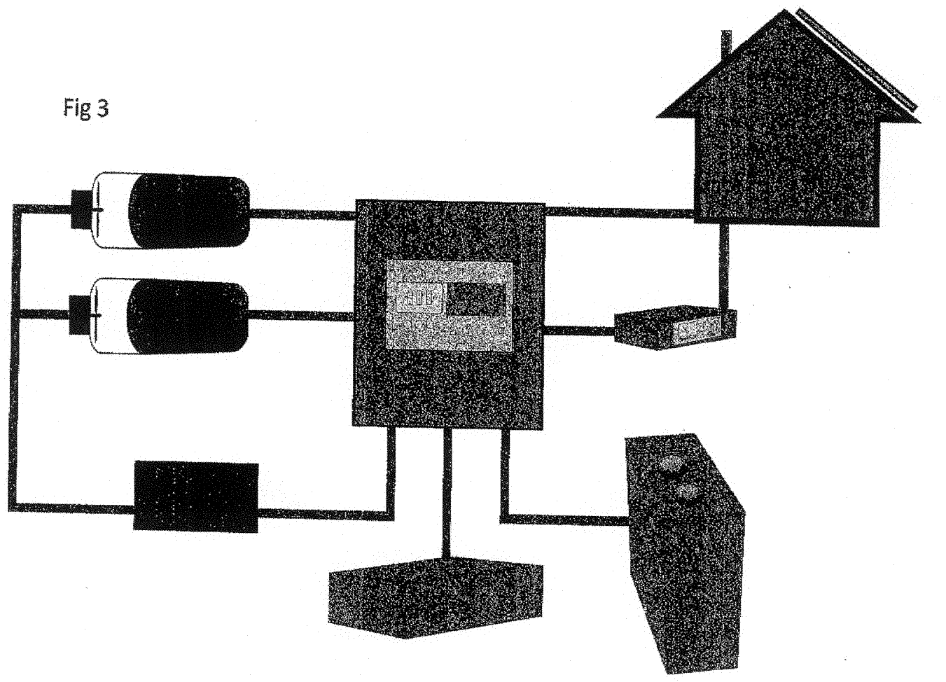

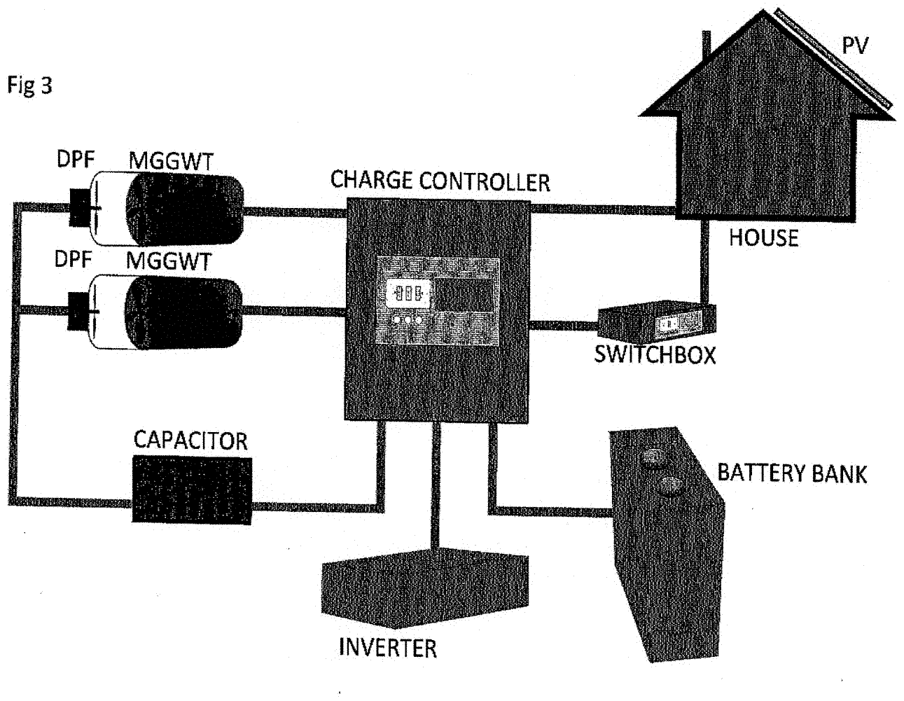

The (MGGWT) connecting energy flow chart FIG. 3 consists of a charge controller, inverter, battery bank storage, switchboard panel, capacitor.

Comprising device units FIG. 3 connecting to (DPF) (MGGWT) systematically can be built and manufactured as a renewable and sustainable energy resource system.

The (DPF) (MGGWT) to be designed volumetrically.

### SUMMARY

The dual powered-fans (DPF) coupling dual magnetic gearless generator wind turbines (MGGWTs) comprising: said grid and off-grid device units connecting to collect kinetic energy of winds to produce energy power. Said energy power is converted into electricity. Additional capacity can be added in incremental stages if property designed and maintained. No wind turbine will become obsolete too quickly.

1. Double-fans #6 and #8 spins dual-turbines #2 and #4. Fans create wind for turbines to generate energy within wind shrouds to control and contain feeding turbines.

2. Turbine #2 compromise the residential and/or commercial dwelling grids. Turbine #4 compromises inverter #10, charge controller #12, battery bank #14, bi-directionally.

3. Inverter #10 splitting energy power, alternating direct current (DC) to alternating current (AC), optional alternating current (AC) to direct current (DC), coupling to the charge controller #12 to battery bank #14, operating on an automatic timer switch (ATS) #16.

4. Charge controller #12 consist of a charging and monitoring data component.

5. Battery bank #14 receives, stores and releases energy for backup power at any given time as needed.

6. Automatic timer switch (ATS) #16 to control manually, automatically and/or on a timely matter.

7. Capacitor bank #18 stores and release electrical energy flow back to fan #6 and #8 and turbine #2 and #4; recurring.

8. Double-fan #6 and #8, dual-turbine #2 and #4, and component units installed and stored in a manufactured utility unit, varying in size as needed.

9. Optional, for an on and off-grid renewable sustainable energy systems.

10. All components varying in sizes to the baseload capacity and volume of calculated areas.
